(19) United States
(12) Patent Application Publication
(10) Pub. No.: US 2013/0073539 A1
(43) Pub. Date: Mar. 21, 2013

(54) System and Method for Collectively Describing Events and Connecting Individuals Based Upon Commonly Shared Experiences to Control Social Network

(71) Applicants: Jason L. Bowser, Harrisburg, PA (US); David M. Johnson, Phoenix, AZ (US); William R. Sutherland, San Jose, CA (US); George Weiss, Carefree, AZ (US); Carlos A. Noguera, Lancaster, PA (US); Nathan Wagner, Scottsdale, AZ (US)

(72) Inventors: Jason L. Bowser, Harrisburg, PA (US); David M. Johnson, Phoenix, AZ (US); William R. Sutherland, San Jose, CA (US); George Weiss, Carefree, AZ (US); Carlos A. Noguera, Lancaster, PA (US); Nathan Wagner, Scottsdale, AZ (US)

(73) Assignee: ARMEDZILLA, INC., Scottsdale, AZ (US)

(21) Appl. No.: 13/239,274

(22) Filed: Sep. 21, 2011

(51) Int. Cl. G06F 17/30

(52) U.S. Cl. 707/722; 707/E17.005; 707/E17.014

(57) ABSTRACT

A commercial and social system is controlled by collecting information related to historical events from veterans and active duty personnel. The historical events are stored in a database as keypoints based on time and location. Personal profile information for the veterans and active duty personnel is also collected and stored in the database. The information stored in the database is accessed based on search selections. A timeline of the historical events is presented based upon matches between the search selections and information stored in the database. A veteran or active duty personnel associated with the historical events is identified. A connection to the identified veteran or active duty personnel is controlled to enable a commercial or social activity with the identified veteran or active duty personnel. The historical events can also relate to sport teams, corporations, professional organizations, government, schools, and other organizations with numerous members.

### FIELD OF THE INVENTION

The present invention relates in general to a commercial and social network and, more particularly, to a system and method of controlling the commercial and social network by collectively describing events and connecting individuals based upon commonly shared experiences.

### BACKGROUND OF THE INVENTION

Each person encounters a variety of life events and possesses a unique set of personal experiences. A young person attends school, may serve in the military, holds a series of jobs, develops many professional and social relationships, raises a family, and then exits the workforce into retirement. The path followed by each person defines his or her collective experiences. In one example, a person may enter the military after high school or college. The person serves for a number of years and then exits the military for one or more jobs in the private sector. Military service often involves a myriad of opportunities, events, problems, and solutions with many professional and social interactions. Likewise, work in the private sector involves many opportunities, events, problems, and solutions with a variety of professional and social interactions. The professional and social interactions during military service are often quite different and usually left behind, while a new set of professional and social interactions begins with life in the private sector. The correlation between the military and private sector is difficult to establish and maintain.

Veterans have a number of assistance and support organizations and groups, e.g., Department of Veterans Affairs (VA), Veterans of Foreign Wars (VFW), Wounded Warrior Project (WWP), American Legion, AMVETS, and Disabled American Veterans (DAV), just to name a few, to help with veterans benefits, veteran issues, and social interactions. However, most of these support organizations and groups have a specific and limited charter. For example, the VA provides federal assistance for veterans in the form of pensions, disabilities, GI bill, medical care, home loans, and burial services. The VFW gives veterans the opportunity to perform community service, lobby for veteran rights and benefits, support needs of retired military families, provide respectful veteran burials, maintain historical military records, and create a social forum for veterans. The WWP assists active duty personnel and veterans with injuries or handicaps. These veterans assistance organizations and programs perform a valuable role in giving veterans and active duty personnel access to specific benefits and services.

Veterans often make contacts with fellow veterans in person through the support organizations and groups. The contacts enable veterans to exchange stories about specific events, locations, and experiences during military life. However, given the vast context and nature of the military, meeting someone with a similar story is rare. When veterans exchange stories, they may find that they served during the same time period or in the same theatre but often in different locations with different units. The correlation is limited and may not provide a basis for further discussion or a common relationship. While veterans tend to naturally migrate toward other veterans, making the connection can be difficult.

The military has an interest in collecting and maintaining an accurate and comprehensive history. The history of the military is usually compiled by historians observing events and interviewing individuals who participated in the events. The published military history is often an overview and limited to the official account controlled by politicians and leaders. The real stories of the troops are rarely documented and, even then, such accounts are limited to a small sample size. The history of the military is an integral part of the heritage of the country and should include many perspectives.

### SUMMARY OF THE INVENTION

A need exists to provide veterans with a forum to bridge the gap between military service and life in the private sector, as well as to document and share their own personal military service to enable connections with other veterans. Accordingly, in one embodiment, the present invention is a method of controlling a commercial and social system comprising the steps of collecting information related to historical events from veterans and active duty personnel, storing the information in a database, providing search selections, accessing the information stored in the database based on the search selections, presenting a timeline of the historical events based upon matches between the search selections and information stored in the database, identifying a veteran or active duty personnel associated with the historical events, and controlling a connection to the identified veteran or active duty personnel to enable a commercial or social activity with the identified veteran or active duty personnel.

In another embodiment, the present invention is a method of controlling a commercial and social system comprising the steps of collecting information related to historical events from members of the commercial and social system, storing the information in a database, accessing the information stored in the database based on search selections, presenting the historical events based upon matches between the search selections and information stored in the database, identifying a member of the commercial and social system associated with the historical events, and controlling a connection to the identified member of the commercial and social system to enable a commercial or social activity with the identified member.

In another embodiment, the present invention is a method of controlling a commercial and social system comprising the steps of collecting information related to historical events from members of the commercial and social system, storing the information in a database, accessing the information stored in the database based on search selections, presenting the historical events based upon matches between the search selections and information stored in the database, and controlling connections between the members of the commercial and social system to enable commercial or social activity.

In another embodiment, the present invention is a computer program product usable with a programmable computer processor having a computer readable program code embodied in a computer usable medium for controlling a commercial and social system comprising the steps of collecting information related to historical events from members of the commercial and social system, storing the information in a database, accessing the information stored in the database based on search selections, presenting the historical events based upon matches between the search selections and information stored in the database, and controlling connections between the members of the commercial and social system to enable commercial or social activity.

### BRIEF DESCRIPTION OF THE DRAWINGS

FIG. 1 illustrates veterans and active duty personnel communicating with a CSISP;

FIG. 2 illustrates a plurality of members within a commercial and social network engaging in commercial and social activity;

FIG. 3 illustrates an electronic communication network between the veteran, CSISP, and other members of the commercial and social network;

FIG. 4 illustrates a computer system operating with the electronic communication network;

FIG. 5 illustrates a personal profile and registration webpage for the veteran to access the CSISP;

FIG. 6 illustrates a login webpage for the veteran to access the CSISP;

FIG. 7 illustrates a webpage for recording personal profile information for the veteran;

FIG. 8 illustrates a webpage for recording a keypoint associated with the veteran and storing the keypoint in a database maintained by the CSISP;

FIG. 9 illustrates a webpage for entering search selections to access information stored in the database maintained by the CSISP;

FIG. 10 illustrates a webpage for presenting a timeline of the keypoints based on the search selections;

FIG. 11 illustrates a webpage for presenting a timeline with sub-timelines;

FIG. 12 illustrates a webpage for presenting a keypoint from the timeline of FIG. 10;

FIG. 13 illustrates a webpage for presenting one or more keypoints in a geographical format;

FIG. 14 illustrates a webpage for presenting overlapping timelines;

FIG. 15 illustrates a webpage for presenting another timeline of the keypoints based on the search selections;

FIG. 16 illustrates a webpage for presenting a keypoint from the timeline of FIG. 15;

FIG. 17 illustrates a webpage for presenting another timeline of the keypoints based on the search selections;

FIG. 18 illustrates a webpage for presenting a keypoint from the timeline of FIG. 17;

FIG. 19 illustrates a webpage for presenting another timeline of the keypoints based on the search selections;

FIG. 20 illustrates a webpage for presenting a timeline of the keypoints from a player on a sports team based on the search selections;

FIG. 21 illustrates the process of controlling a connection to an identified veteran or active duty personnel to enable a commercial or social activity with the identified veteran or active duty personnel; and

FIG. 22 illustrates the process of controlling connection to members of the commercial and social system to enable commercial or social activity with the members of the commercial and social system.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Each person encounters a variety of life events and possesses a unique set of personal experiences. A young person attends school, may serve in the military, holds a series of jobs, develops many professional and social relationships, raises a family, and then exits the workforce into retirement. The path followed by each person defines his or her collective experiences. In one example, a person may enter the military after high school or college. Military service often involves a myriad of opportunities, events, problems, and solutions with many professional and social interactions. The active duty person serves for a number of years and then exits the military usually for one or more jobs in the private sector. Upon discharge from the military, the person is classified as a veteran.

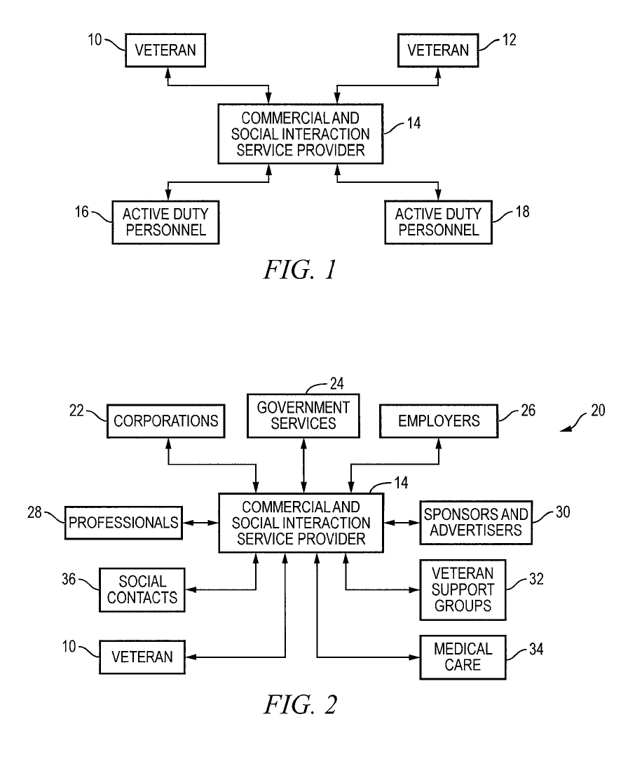

FIG. 1 shows veterans 10 and 12 communicating with commercial and social interaction service provider (CSISP) 14. Active duty personnel 16 and 18 can also communicate with CSISP 14. Veterans 10 and 12 and active duty personnel 16 and 18 store facts and experiences about their personal profile and military life in CSISP 14. Veterans 10 and 12 and active duty personnel 16 and 18 can search CSISP 14 to locate and communicate with other veterans and active duty personnel having similar military backgrounds or that are otherwise of interest. The connection established between veterans 10 and 12 and active duty personnel 16 and 18 through CSISP 14 enables the parties to engage in commercial and social activities.

For example, assume veteran 10 served in Iraq during 2005 in a particular unit under a particular commanding officer. Veteran 12 served in Iraq during 2006 in the same unit under the same commanding officer. Veteran 10 knows many of the same people from the deployment as veteran 12 and may have overlapped in country for a short time. Veteran 10 now lives in the same community as veteran 12, but does not know veteran 12. Veteran 10 can search CSISP 14, e.g., based on time period, duty station, and specialization, and then view a timeline of events, locations, and other facts about other persons matching the search criteria. CSISP 14 enables veteran 10 to locate and communicate with veteran 12. Veteran 10 and veteran 12 will likely have much in common. Veteran 10 may need the professional services of veteran 12. CSISP 14 provides the conduit for veterans 10 and 12 to connect and engage in commercial and social activities.

In another example, active duty person 16 is presently stationed at Fort Bragg, N.C. Active duty person 16 has a particular interest, e.g., playing a musical instrument or an affinity for sports, and wants to find other active duty personnel in a nearby unit with similar interests. Active duty person 16 can search CSISP 14, e.g., based on time period, duty station, and interests, and then view a timeline of events, locations, and facts about other veterans or active duty personnel matching the search criteria. CSISP 14 enables active duty person 16 to locate and communicate with veterans 10 or 12 or active duty person 18. CSISP 14 provides the conduit for active duty personnel 16 and 18 to connect and engage in commercial and social activities.

FIG. 2 illustrates a commercial and social network (CSN) 20 involving veteran 10 working with and through CSISP 14 to conduct commercial, professional, support, and social interactions with other members of CSN 20. CSN 20 includes corporations 22, government services 24, employers 26, professionals 28, sponsors and advertisers 30, veteran support groups 32, medical care 34, and social contacts 36. The above members of CSN 20 can be veterans or active duty personnel. Corporations 22 offer employment opportunities, as well as products and services of interest to veterans and active duty personnel. Government services 24 provide health care, disability services, and other support for veterans and active duty personnel. Employers 26 offer employment opportunities, as well as products and services of interest to veterans and active duty personnel. Professionals 28 offer services of need or interest to veterans and active duty personnel. Sponsors and advertisers 30 want to target veterans and active duty personnel. Veteran support groups 32 offer assistance to veterans. Medical care 34 provides medical care for veterans. Social contacts 36 provides a forum for veterans and active duty personnel with a common interest or shared experience to connect and engage in social interaction.

Veteran 10 is interested in contacting other members of CSN 20 for commercial, professional, support, and social purposes. Veteran 10 has a preference for working with or otherwise contacting other veterans because of the unique personal bond between veterans. In one example, veteran 10 is looking for employment. Veteran 10 can search CSISP 14 for veterans in corporations 22 or employers 26 with common backgrounds, locations, job skills, and experiences. The chances of finding a job greatly increases with another veteran that veteran 10 shares a common history. In another example, veteran 10 is looking for professional services, e.g., accountant, realtor, auto mechanic, or investment advisor, and would prefer to find someone, i.e., another veteran, that he or she knows or can trust. CSISP 14 can link veteran 10 to another veteran with the requisite skills. In another example, veteran 10 wants to locate other nearby veterans that served on the same naval vessel for social purposes. CSISP 14 can link veteran 10 to other veterans with common service records. In another example, veteran support groups 32 wants to locate veterans that have particular issues which the support group can assist. CSISP 14 can link veteran support groups 32 to target veterans.

Most if not all members of CSN 20 engage in commercial, professional, support, and social activities that may involve veterans. Veteran 10 uses CSISP 14 to locate and connect with other members of CSN 20. The interaction between veteran 10 and CSISP 14 affects control over CSN 20 by connecting the parties to initiate and engage in the commercial, professional, support, and social activity. CSISP 14 is a key resource and catalyst in controlling the connection that veteran 10 uses to enable the commercial, professional, support, and social activity with other members of CSN 20. That is, but for the connection provided by CSISP 14, the commercial, professional, support, and social activity between veteran 10 and other members of CSN 20 would not have happened, at least not in the manner that did occur with CSISP 14. CSISP 14 establishes the connection and affinity between parties to engage in commercial, professional, support, and social activity with members of CSN 20. The control over the connection between veteran 10 and other members of CSN 20 through CSISP 14 migrates a change of state within CSN 20 by nature of the social, professional, support, and social activity by and between the members of the CSN.

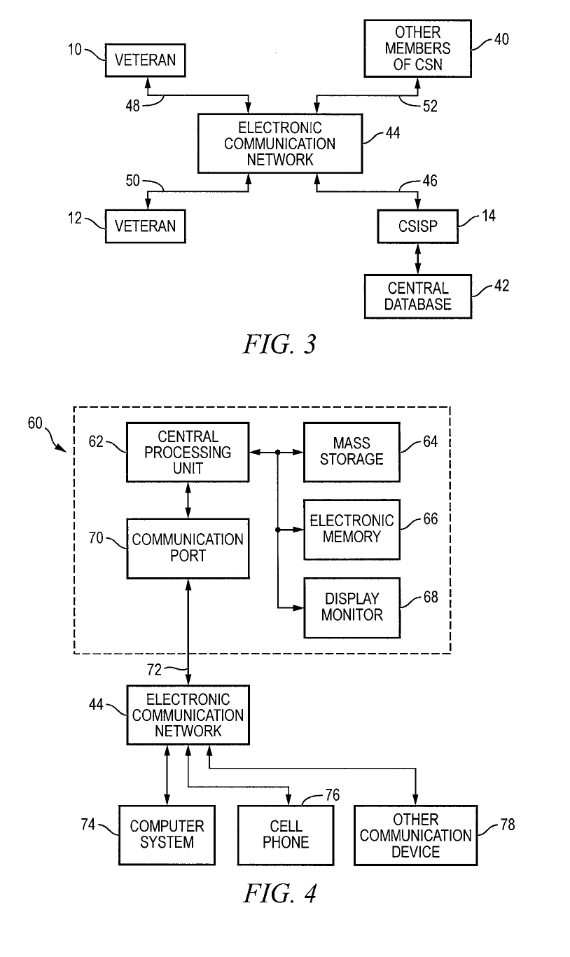

FIG. 3 illustrates further detail of the interaction between veteran 10, veteran 12, CSISP 14, and other members of CSN 40 associated with enabling an opportunity to connect with and engage in commercial, professional, support, and social activity by and between the members of the CSN. The other members of CSN 40 include members 22-34. CSISP 14 is a third party service provider that assists veterans and active duty personnel with the collection, maintenance, and searching of personal profiles and keypoints related to military service and experiences. A keypoint is a record, created by veteran 10 or 12 or other member of CSN 40 and stored in central database 42, that documents one or more events during his or her life in the military. A keypoint includes data such as time, location, description of events, pictures, video, and other media. For example, a keypoint can be a routine security patrol in Iraq on a particular date. Veteran 10 or 12 or active duty personnel 16 or 18 creates a keypoint record in central database 42 with time, location in terms of town, region, or longitude and latitude coordinates, written description, photographs, and videos from the security patrol. Veteran 10 or 12 or active duty personnel 16 or 18 can enter a number of keypoints each documenting one or more events. CSISP 14 works with veteran 10, veteran 12, and other members of CSN 40 by collecting, storing, and searching personal profiles and keypoints. The keypoints selected using a search pattern can be organized and presented as a timeline or map of military service and experiences.

In order for CSISP 14 to provide efficient and effective interactions between veteran 10, veteran 12, and other members of CSN 40, central database 42 must be populated with comprehensive, reliable, and accurate personal profiles, keypoints, and other data. CSISP 14 collects data from a variety of public and private data sources within CSN 20 through an electronic communication network 44. Electronic communication network 44 contains bi-directional electronic communication channels or links between veteran 10, veteran 12, and other members of CSN 40. For example, CSISP 14 is connected to electronic communication network 44 by way of electronic communication channel or link 46. Likewise, veteran 10 is connected to electronic communication network 44 by way of electronic communication channel or link 48. Veteran 12 is connected to electronic communication network 44 by way of electronic communication channel or link 50. The other members of CSN 40 are connected to electronic communication network 44 by way of electronic communication channel or link 52.

Electronic communication network 44 is a distributed network of interconnected routers, gateways, switches, and servers, each with a unique address to enable communication between individual computers, cellular telephones, electronic devices, or nodes within the network. In one embodiment, electronic communication network 44 is a global, open-architecture network, commonly known as the Internet. Alternatively, electronic communication network 44 is a wireless telephone network. Electronic communication channels or links 46-52 are bi-directional and transmit data between the users and electronic communication network 44 in a hard-wired or wireless configuration. For example, CSISP 14 operates a computer system with standard operating system, document processing software, email, texting, and Internet capability. Veteran 10 and 12 can operate a computer system with standard operating system, document processing software, email, texting, and Internet capability. The other members of CSN 40 can operate a computer system with standard operating system, document processing software, email, texting, and Internet capability.

Further detail of the computer systems used in communication system 44 is shown in FIG. 4 as a simplified computer system 60 for executing the software program used in the electronic communication process. Computer system 60 is a general purpose computer including a central processing unit or microprocessor 62, mass storage device or hard disk 64, electronic memory 66, display monitor 68, and communication port 70. Communication port 70 represents a modem, high-speed Ethernet link, wireless, or other electronic connection to transmit and receive input/output (I/O) data over communication link 72 to electronic communication network 44. Computer system or server 74 can be configured in the same manner as shown for computer 60. Computer system 74 and cellular telephone 76 transmit and receive information and data over communication network 44. Other electronic devices 78 can also transmit and receive information and data over electronic communication network 44.

Computer systems 60 and 74 can be physically located in any location with access to a modem or communication link to network 44. For example, computer 60 and 74 can be located in the user's home or business office. Alternatively, computer 60 and 74 can be mobile and follow the user to any convenient location, e.g., remote offices, customer locations, hotel rooms, residences, vehicles, public places, or other locales with electronic access to communication network 44. CSISP 14 may use computer system 60 in its business office. Veteran 10 can use computer system 74 in his or her business office or home. Veteran 12 can access CSISP 14 by mobile application operating in cell phone 76.

Each of the computers runs application software and computer programs, which can be used to display user interface screens, execute the functionality, and provide the electronic communication features as described below. The application software includes a local email application, Internet browser, word processor, spreadsheet, and the like. In one embodiment, the screens and functionality come from the application software, i.e., the electronic communication runs directly on computer system 60. Alternatively, the screens and functions are provided remotely from one or more websites on servers within electronic communication network 44.

The software is originally provided on computer readable media, such as compact disks (CDs), flash drives, external drive, or other mass storage medium. Alternatively, the software is downloaded from electronic links, such as the host or vendor website. The software is installed onto the computer system hard drive 64 and/or electronic memory 66, and is accessed and controlled by the computer's operating system. Software updates are also electronically available on mass storage medium or downloadable from the host or vendor website. The software, as provided on the computer readable media or downloaded from electronic links, represents a computer program product containing computer readable program code embodied in a computer program medium.

CSISP 14 uses electronic communication network 44 to collect personal profiles, keypoints, and other data from veterans 10 and 12 and active duty personnel 16 and 18 and stores the data in central database 42. CSISP 14 also communicates with other members of CSN 40 to collect other data related to veterans 10 and 12 and active duty personnel 16 and 18. For example, CSISP 14 communicates with government services 24 to collect or confirm military records of veterans 10 and 12 and active duty personnel 16 and 18, including service dates, branch of service, duty stations, commanding officers, service training, and medical records. Access to military records from government services 24 can be authorized by appropriate authorities, or by veterans 10 and 12 and active duty personnel 16 and 18. CSISP 14 can also obtain military information from other public and private sources, e.g., war colleges of various service branches, military academies, VA, and Smithsonian. As CSISP 14 gains acceptance and veterans 10 and 12 and active duty personnel 16 and 18 come to rely on the service to make contacts and engage in commercial and social activities, other members of CSN 40 will be motivated to provide authorization to disclose private information to CSISP 14 in order to maximize opportunities to connect with other participants.

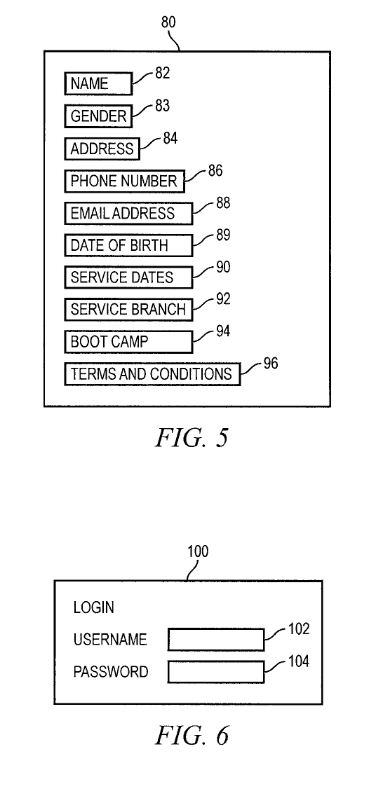

To access the information contained in central database 42, veteran 10 first creates an account and personal profile with CSISP 14. The account set-up involves a registration process wherein the user accesses website 80 operated by CSISP 14 and provides data to complete the registration and activation process, as shown in FIG. 5. Veteran 10 can access registration website 80 by computer 74 or cellular telephone 76 by typing the uniform resource locator (URL) for website 80, or by clicking on a banner located on another website, which re-directs the user to predetermined landing pages for website 80. In one embodiment, registration webpage 80 includes name in block 82, gender in block 83, address in block 84, phone number in block 86, email address in block 88, date of birth in block 89, service dates in block 90, service branch in block 92, boot camp 94, and other information and credentials necessary to establish a personal profile and identity for veteran 10. Veteran 10 agrees to the terms and conditions of conducting electronic communication through CSISP 14 in block 96. CSISP 14 may require a paid subscription from veteran 10 to access and utilize its services. CSISP 14 can also rely on advertising and sponsorships as a revenue source.

Veteran 10 can access CSISP 14 through webpage 100 by entering username 102 and password 104, as shown in FIG. 6. The username can be the phone number or email address and the password assigned to or selected by veteran 10. Veteran 10 can change personal information, and otherwise update the profile. The personal profile of veteran 10 remains secure and confidential within CSISP 14.

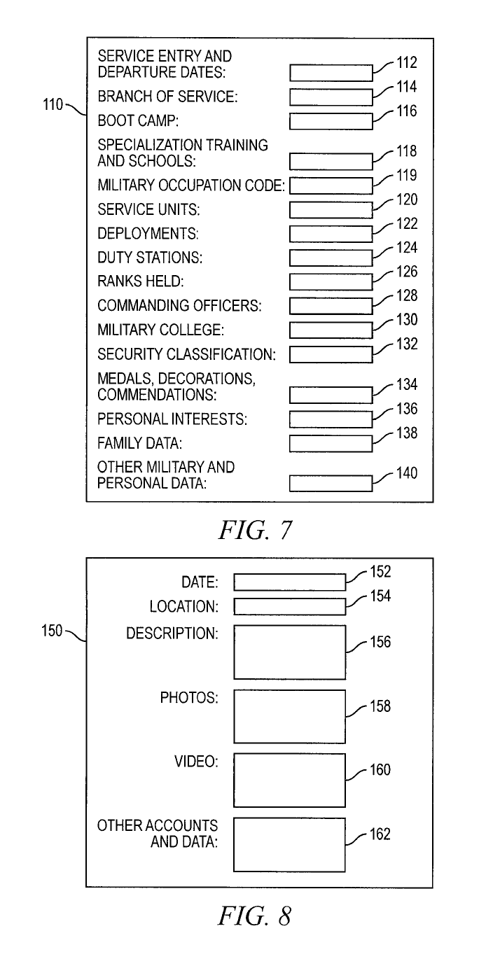

Once logged into the CSISP website, veteran 10 is presented a home page with options to update his or her personal profile, enter specific keypoints, provide additional general information, and execute searches. For example, veteran 10 can enter personal profile and other general information in CSISP webpage 110 relevant to his or her military service, as shown in FIG. 7. In webpage 110, veteran enters service entry and departure dates in block 112, branch of service in block 114, boot camp in block 116, specialization training and schools in block 118, military occupation code in block 119, service units in block 120, deployments in block 122, duty stations in block 124, ranks or grades held in block 126, commanding officers in block 128, military academy or college in block 130, security classification in block 132, medals, decorations and commendations in block 134, personal interests in block 136, family data in block 138, and other military service and personal data in block 140.

Some of the data entered in webpage 110 can imply or provide confirmation other facts, e.g., a certain rank or grade necessarily involves certain training or schools. Webpage 110 can auto-populate or perform error checking on the data in certain blocks against other blocks. If veteran 10 enters Ranger status in block 140, then the specialized training or school block cannot be blank. If veteran 10 enters a service unit without corresponding deployment known to have occurred for that service unit, then CSISP 14 notes the discrepancy. The general information in webpage 110 is applicable to most if not all keypoints and other records pertaining to veteran 10. CSISP 14 stores the personal profile and general information for veteran 10 in central database 42.

Veteran 10 can enter a keypoint in CSISP webpage 150, as shown in FIG. 8. In webpage 150, veteran 10 can enter relevant date(s) for the keypoint in block 152, location of the keypoint in terms of town, region, or longitude and latitude coordinates in block 154, description of keypoint in block 156, photos in block 158, videos in block 160, and other relevant accounts and data in block 162. For example, the keypoint may relate to a security patrol in a particular town in Iraq on a given date. The keypoint description provides an account of the patrol, e.g., orders for the patrol, type of terrain, natural and manmade structures, conditions on the ground, strength of force, enemy encountered, exchange of fire, casualties, prisoners taken, intelligence gathered, medical assistance rendered to civilians, length of patrol, exit scenario, and other notable accounts.

In another example, the keypoint may relate to a naval deployment in which veteran 10 crossed the equator for the first time. In a ceremony, commonly referred to as “Crossing the Line”, veteran 10 is subjected to a variety of hazing, degradations, humiliations, and unceremonious initiations to transform the sailor from a slimy or pollywog to a Son of Neptune or shellback. The ceremony is intended to be all in good fun, as least for the existing shellbacks, and memorable for the pollywogs. At the end of the day, pollywogs are given a coveted certificate to document their transformation to a shellback status and avoid enduring the ceremony again. Veteran 10 can enter the dates of the ceremony in block 152, location of equatorial crossing in terms of longitude and latitude coordinates in block 154, description of events during the ceremony in block 156, photos in block 158, videos in block 160, and other relevant accounts and data in block 162.

A keypoint can be any event or recollection during military service that is meaningful or important to veteran 10. Veteran 10 can enter a number of different keypoints through webpage 150. The keypoints for veteran 10 defined a timeline or map of military service for the veteran. The more keypoints, the more accurate and comprehensive the timeline or map. CSISP 14 stores the keypoints for veteran 10 in central database 42.

Veteran 10 is the owner of the keypoints and controls the content, within the policy guidelines of CSISP 14. CSISP 14 has the ability to monitor the content of central database 42 and strike or block any content that violates its policy. For example, if veteran 10 falsifies data, e.g., the person never served in the military or falsely claims rank, training, medals, or commendations, then CSISP 14 can remove or block the keypoint entries or delete the account altogether. If the keypoints violate national security, CSISP 14 can remove or block the content. If the keypoints are inappropriate in content, e.g., pornography or criminal acts, CSISP 14 can remove or block the content. If the keypoints contain false, libelous, defamatory, or other misrepresentative accounts of other veterans, CSISP 14 can remove or block the content. Other users can provide feedback to CSISP 14 and comment on accuracy, inconsistencies, and inappropriate content of personal profiles and keypoints. CSISP 14 investigates the report from other users and takes appropriate corrective action.

Veteran 12 and active duty personnel 16 and 18 also create personal profiles and enter keypoints as described for veteran 10. Each veteran or active duty personnel profiled in CSISP 14 has a timeline defined by the keypoints he or she has recorded in central database 42. Central database 42 is organized to readily and efficiently access the personal profiles and keypoints for its members. In one embodiment, central database 42 contains personal profile, general information records, and other metadata for veteran 10 with the information collected in webpages 80 and 110. The personal profile and general information is applicable to most if not all keypoints and other records pertaining to veteran 10. Central database 42 also contains keypoint records and related metadata for veteran 10 with the information collected in webpage 150.

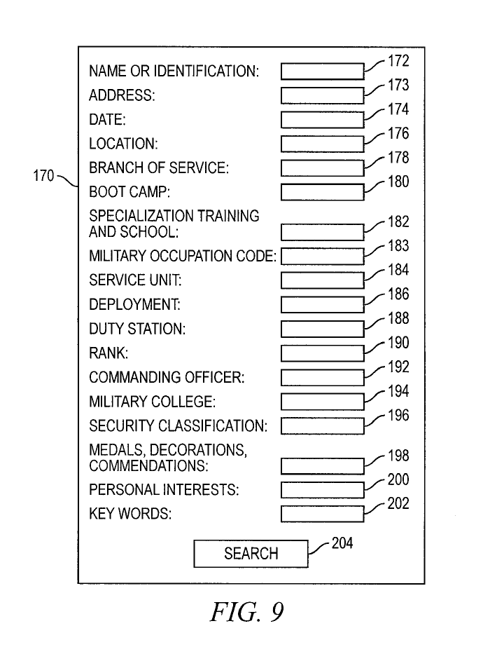

CSISP 14 provides a search feature to locate and retrieve personal profiles and keypoints stored in central database 42. In FIG. 9, CSISP webpage 170 shows a number of search blocks for entering search selections or criteria. A user of CSISP 14 can be veteran 10 or 12, active duty personnel 16 or 18, other members of CSN 40, or any other person interested in accessing the data contained in central database 42. The user can enter veteran name or identification in block 172, present address in block 173, date in block 174, location in terms of town, region, or longitude and latitude coordinates in block 176, branch of service in block 178, boot camp in block 180, specialization training and school in block 182, military occupation code in block 183, service unit in block 184, deployment in block 186, duty station in block 188, rank or grade in block 190, commanding officer in block 192, military academy or college in block 194, security classification in block 196, medals, decorations and commendations in block 198, personal interests in block 200, and other key words in block 202.

Search webpage 170 allows the user to make selections and enter data by clicking buttons with a mouse, typing into data fields with the keyboard, or selecting predetermined values from drop-down menus. Alternatively, if the user accesses CSISP 14 through a mobile application on a mobile device such as a cellular phone, the user can select features by using a touch-sensitive display screen on the mobile phone. The user defines one or more search selections in blocks 172-202 and clicks on search button 204. The search selections can be natural language format searches. CSISP 14 accesses central database 42 and retrieves the records matching the search selections and presents related keypoints. The matching process conducted by CSISP 14 can be based on a weighted relevance of the data in central database 42. The weighted relevance can be applied to search criteria important to the user, e.g., time, location, or commanding officer to increase its relevance to the search process. For example, the user may place more emphasis on location than rank and therefore give location a higher weighting.

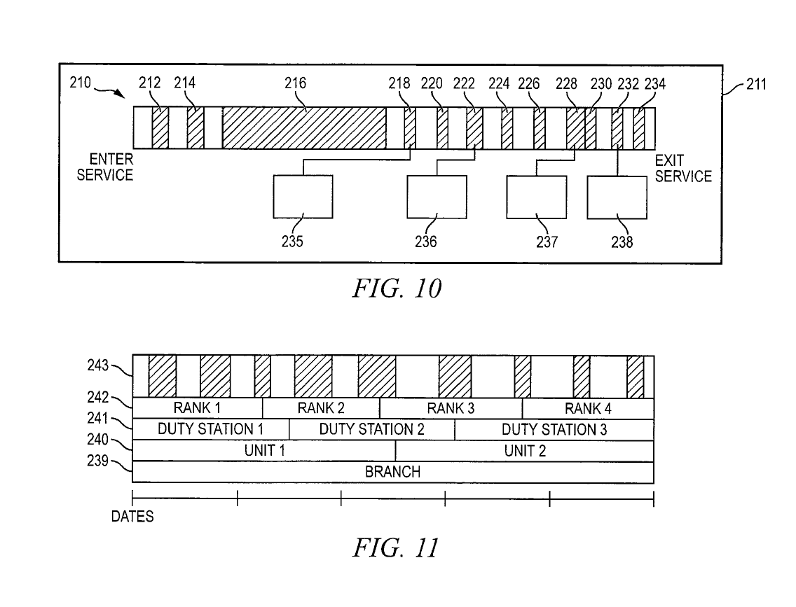

If the user enters the name or identification of veteran 10 in block 172, with all other blocks blank, CSISP 14 accesses central database 42 and retrieves all personal profile, general information and keypoints for the selected veteran. The keypoints can be organized in a timeline. FIG. 10 shows the search results as timeline 210 with a plurality of keypoints applicable to veteran 10 in webpage 211. Timeline 210 spans from the date of entry into military service to the date of departure from military service. Keypoint 212 relates to boot camp, keypoint 214 relates to specialized training at sniper school, keypoint 216 relates to deployment in Iraq, keypoint 218 relates to a sporting event on base with fellow servicemen, keypoint 220 relates to an injury received during a mission, keypoint 222 relates to a leave trip to a local town with buddies, keypoint 224 relates to a service commendation ceremony, keypoint 226 relates to leave at home with family during Christmas, keypoint 228 relates to a security patrol during deployment in Iraq, keypoint 230 relates to loss of a comrade during the patrol in keypoint 228, keypoint 232 relates to departure from the Iraq duty station to return stateside, and keypoint 234 relates to departure party from military service.

A sample photo and summary description from the keypoint can be displayed below timeline 210. In webpage 211, photo and summary description 235 relate to keypoint 218, photo and summary description 236 relate to keypoint 222, photo and summary description 237 relate to keypoint 228, and photo and summary description 238 relate to keypoint 232.

Keypoints 212-234 are arranged in chronological order and can be logically grouped. Timeline 210 establishes a correlation between keypoints 212-234. Multiple timelines can be shown for a person who departs and reenlists in the military. Keypoints 212-234 are more than a sequence of unique datapoints in time and location but rather related events that define a storyline and historical record from the person(s) with the most knowledge of the specific details.

The overall search timeline can be separated into sub-timelines 239, 240, 241, and 242 representing various status changes and attributes over the time period of keypoints 243, as shown in FIG. 11. Sub-timeline 239 shows a common branch of service over the time period of keypoints 243. Sub-timeline 240 shows different service units with associated time periods over the total time of keypoints 243. Sub-timeline 241 shows different duty stations with associated time periods over the total time of keypoints 243. Sub-timeline 242 shows different ranks with associated time periods over the total time of keypoints 243.

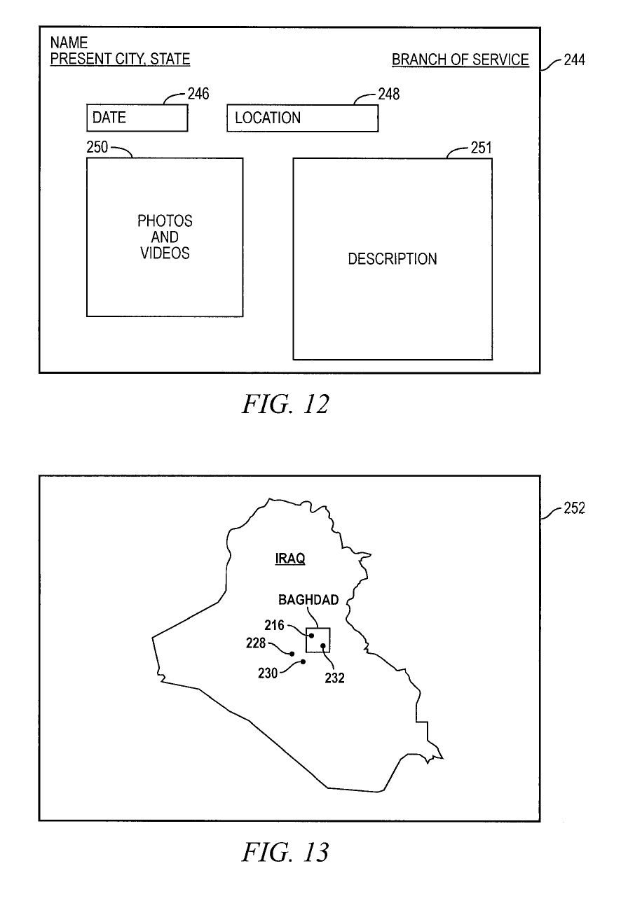

Keypoints 212-234 can be individually selected for further detail by clicking on the keypoint with a mouse. If keypoint 214 is selected, then the details of the specialized training at sniper school are displayed on webpage 244, as shown in FIG. 12. The details of keypoint 214 show the dates in block 246, location in terms of town, region, or longitude and latitude coordinates in block 248, photos, video or other media in block 250, and description of the sniper school in block 251 including other candidates in the school, types of training exercises, and performance or scores achieved on training exercises. The description of keypoint 214 in block 251 can include links to other keypoints. For example, the description of training exercises in block 251 can include a link to keypoint 220 and how the training saved his or her life but still resulted in an injury received during a mission. Webpage 211 can also show data from the personal profile and general information in FIG. 7, such as branch of service, service unit, duty station, commanding officer, and rank during time period of keypoint 214. Timeline 210 can be shown above keypoint 214 in webpage 244.

If keypoint 226 is selected, then the details of the leave at home with family during Christmas are displayed on webpage 244. The details of keypoint 226 show the dates in block 246, location in terms of town, region, or longitude and latitude coordinates in block 248, photos, video or other media in block 250, and description of the homecoming in block 251 including family members present, gifts given and received, and other special moments. Timeline 210 can be shown above keypoint 226 in webpage 244.

If keypoint 228 is selected, then the details of the security patrol during the deployment in Iraq are displayed on webpage 244. The details of keypoint 228 show the date in block 246, location in terms of town, region, or longitude and latitude coordinates in block 248, photos, video or other media in block 250, and description of the patrol in block 251 including orders, type of terrain, natural and manmade structures, conditions on the ground, strength of force, enemy encountered, exchange of fire, casualties, prisoners taken, intelligence gathered, medical service rendered to civilians, length of patrol, exit scenario, and other notable accounts. The description of keypoint 228 in block 251 can include links to other keypoints. For example, the description of casualties in block 251 can include a link to keypoint 230 relating to the loss of a comrade. Webpage 244 can also show data from the personal profile and general information in FIG. 7, such as branch of service, service unit, duty station, commanding officer, and rank during time period of keypoint 228. Timeline 210 can be shown above keypoint 228 in webpage 244.

Keypoints 212-234, or portion of the keypoints, can also be presented in a map or geographical format. FIG. 13 shows a webpage 252 with keypoints 216, 228, 230, and 232 related to activities in Iraq displayed as a map with geographical correlation.

Keypoints 212-234 identify veteran 10 as being associated with one or more of the events described in the keypoints. If the user is interested in contacting veteran 10 based on the content of keypoints 212-234, then CSISP 14 can provide a connection between the user and veteran 10 to engage in commercial or social activity, as described in FIG. 2.

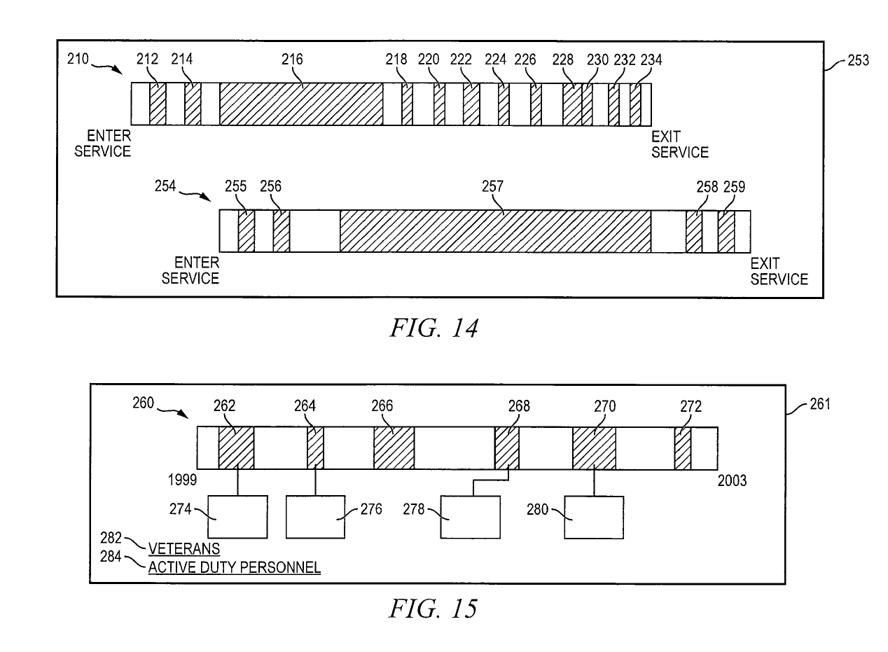

Multiple timelines can be overlapped to associate common events. FIG. 14 shows webpage 253 with timeline 210 for veteran 10 overlapping with timeline 254 for veteran 12. Timeline 254 spans from the date of entry into military service to the date of departure from military service for veteran 12. Keypoint 255 relates to boot camp, keypoint 256 relates to specialized training at sniper school, keypoint 257 relates to deployment in Iraq, keypoint 258 relates to departure from the Iraq duty station to return stateside, and keypoint 259 relates to departure party from military service. Veterans 10 and 12 can learn from overlapping timelines 210 and 254 that both attended the same sniper school and both were stationed in Iraq although at different times. Veterans 10 and 12 will have much to talk about. If veteran 10 or 12 is interested in contacting the other based on the content of keypoints 212-234 or keypoints 255-259, then CSISP 14 can provide a connection to engage in commercial or social activity, as described in FIG. 2.

In another search example, the user can enter a date range in block 174 and duty station in block 188. For example, the user is interested in CSISP records for people serving on the USS Cushing (DD-985) in 1999-2003. Cushing is a Spruance-class destroyer in service from 1979 to 2005. The user enters “1999-2003” in block 174 and “Cushing” in block 188. CSISP 14 retrieves the records from central database 42 matching the search criteria and presents the related keypoints as a timeline. The matching process conducted by CSISP 14 can be based on a weighted relevance of the data in central database 42. The weighted relevance can be applied to search criteria important to the user, e.g., time, location, or commanding officer to increase its relevance to the search process. For example, the user may place more emphasis on location than rank and therefore give location a higher weighting. CSISP 14 also presents a linked list of veterans 10 and 12 and active duty personnel 16 and 18 serving on Cushing during 1999-2003.

FIG. 15 shows the search results as timeline 260 with a plurality of keypoints from all records in central database 42 applicable to Cushing during 1999-2003 in webpage 261. Keypoint 262 relates to 38^{th} Foal Eagle exercise in 1999, keypoint 264 relates to ship ASW readiness effectiveness measuring (SHAREM) 138 in 2000, key point 266 relates to missile exercise (MISSILEX) 01-1 in 2000, keypoint 268 relates to a naval surface fire support exercise in 2000 when Cushing received a better-than-perfect gun shoot score, keypoint 270 relates to the Silver Enlisted Surface Warfare Excellence Pennant received in 2001, and keypoint 272 relates to a joint exercise Annualex 15G in 2003. Keypoints 262-272 are arranged in chronological order and can be logically grouped. Keypoints 262-272 are retrieved from keypoints entered by veterans 10 and 12 and active duty personnel 16 and 18, as well as historical military records.

Timeline 260 establishes a correlation between keypoints 262-272. Keypoints 266-272 are more than a sequence of unique datapoints in time and location but rather related events that define a storyline and historical record from the people with the most knowledge of the specific details. The details between related keypoints may differ and one keypoint may offer a different perspective of the same event than another keypoint but such differences are nonetheless valuable because an accurate and comprehensive historical record necessarily contains a variety of viewpoints. The true story is conveyed by understanding each perspective of the participants to timeline 260.

A sample photo and summary description from the keypoint can be displayed below timeline 260. In webpage 261, photo and summary description 274 relate to keypoint 262, photo and summary description 276 relate to keypoint 264, photo and summary description 278 relate to keypoint 268, and photo and summary description 280 relate to keypoint 270. The user can select link 282 to see a list of veterans who served on Cushing, or select link 284 to see a list of active duty personnel who served on Cushing.

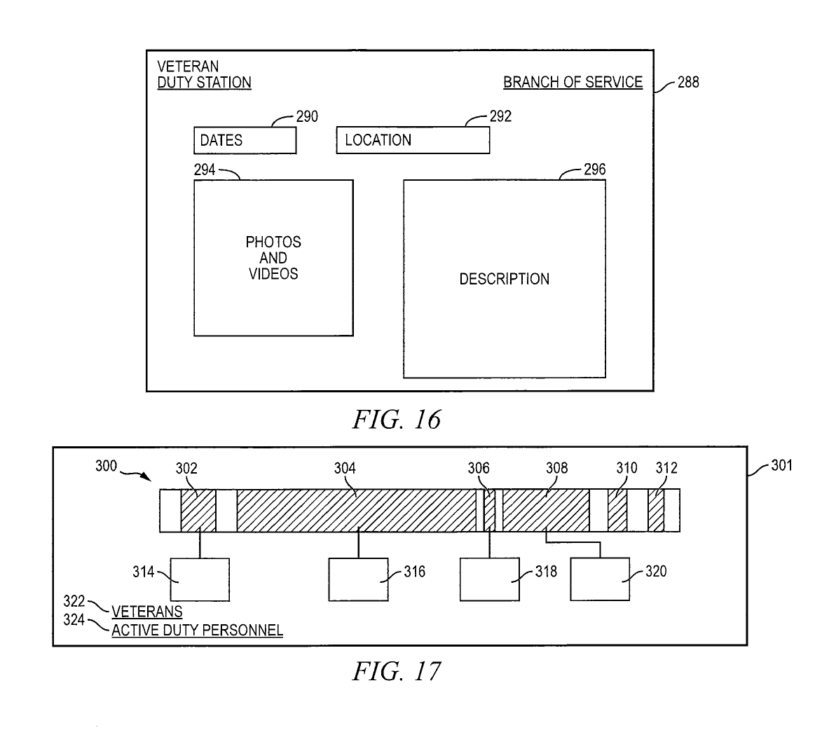

Keypoints 262-272 can be individually selected for further detail by clicking on the keypoint with a mouse. If keypoint 270 is selected, then the details of the naval surface fire support exercise, as recorded in a keypoint created by veteran 10, are displayed on webpage 288 in FIG. 16. The details of keypoint 270 show the dates in block 290, location in terms of longitude and latitude coordinates in block 292, photos, video or other media in block 294, and description of the naval surface fire support exercise in block 296. Veteran 10 may have been on the gunnery crew that achieved the better-than-perfect gun shoot score and can provide a unique insight from a crewman point of view as to the effort and teamwork involved. Webpage 288 can also show data from the personal profile and general information in FIG. 7, such as branch of service, service unit, duty station, commanding officer, and rank during time period of keypoint 270. Timeline 260 can be shown above keypoint 270 in webpage 288.

Keypoints 262-272 identify a veteran or active duty person as being associated with the events described in one or more of the keypoints. If the user is interested in contacting the veteran or active duty person based on the content of keypoints 262-272, then CSISP 14 can provide a connection between the user and the identified veteran or active duty person from the selected keypoint to engage in commercial or social activity, as described in FIG. 2.

In another search example, the user can enter an address in block 173 and duty station in block 188. For example, the user is interested in CSISP records for people serving in the Vietnam War and presently living in the user's community, e.g., Phoenix, Ariz. The user wants to find local Vietnam veterans and possibly establish a personal connection. The user enters “Phoenix, Ariz.” in block 173 and “Vietnam” in block 176. The matching process conducted by CSISP 14 can be based on a weighted relevance of the data in central database 42. The weighted relevance can be applied to search criteria important to the user, e.g., time, location, or commanding officer to increase its relevance to the search process. For example, the user may place more emphasis on location than rank and therefore give location a higher weighting. CSISP 14 retrieves the records from central database 42 matching the search criteria and presents the related keypoints as a timeline. CSISP 14 also presents a linked list of veterans 10 and 12 and active duty personnel 16 and 18 serving in Vietnam and presently living in Phoenix.

FIG. 17 shows the search results as timeline 300 with a plurality of keypoints from all records in central database 42 applicable to the Vietnam War in webpage 301. Keypoint 302 relates to deployment of US military advisors in 1950, keypoint 304 relates to escalation of US involvement during 1961-1968, keypoint 306 relates to the Tet offensive in 1968, keypoint 308 relates to bombing campaign of North Vietnam during 1969-1972, keypoint 310 relates to the Easter offensive in 1972, and keypoint 312 relates to withdraw of US military in 1975. Keypoints 302-312 are arranged in chronological order and can be logically grouped. Keypoints 302-312 are retrieved from keypoints entered by veterans 10 and 12 and active duty personnel 16 and 18, as well as historical military records.

Timeline 300 establishes a correlation between keypoints 302-312. Keypoints 302-312 are more than a sequence of unique datapoints in time and location but rather related events that define a storyline and historical record from the people with the most knowledge of the specific details. The details between related keypoints may differ and one keypoint may offer a different perspective of the same event than another keypoint but such differences are nonetheless valuable because an accurate and comprehensive historical record necessarily contains a variety of viewpoints. The true story is conveyed by understanding each perspective of the participants to timeline 300.

A sample photo and summary description from the keypoint can be displayed below timeline 300. In webpage 301, photo and summary description 314 relate to keypoint 302, photo and summary description 316 relate to keypoint 304, photo and summary description 318 relate to keypoint 306, and photo and summary description 320 relate to keypoint 308. The user can select link 322 to see a list of veterans who served in Vietnam and presently live in the user's community, or select link 324 to see a list of active duty personnel who served in Vietnam and presently live in the user's community.

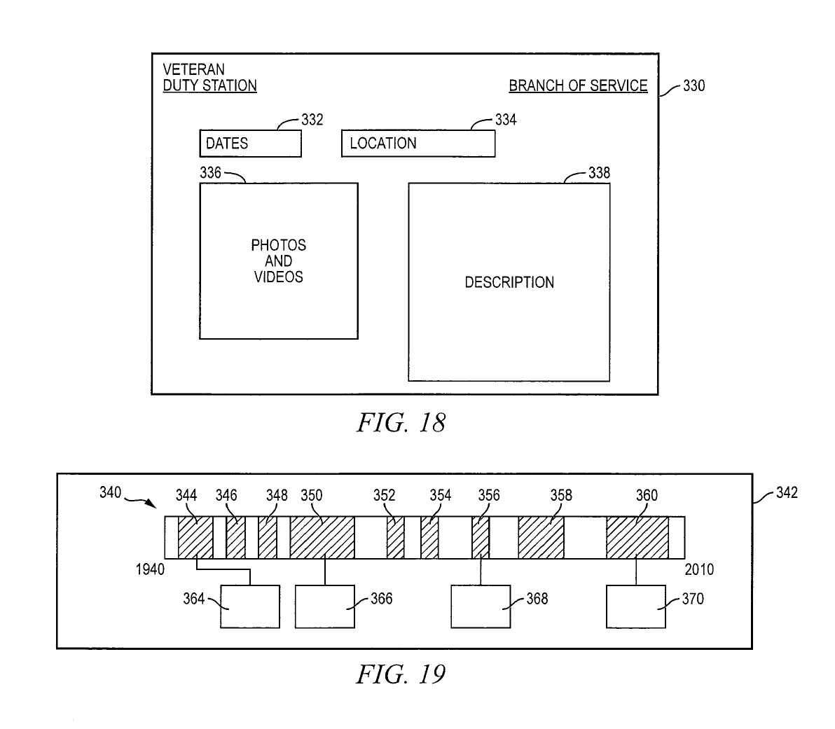

Keypoints 302-312 can be individually selected for further detail by clicking on the keypoint with a mouse. If keypoint 306 is selected, then the details of the Tet offensive, as recorded in a keypoint created by veteran 10, are displayed on webpage 330 in FIG. 18. The details of keypoint 306 show the dates in block 332, location in terms of town, region, or longitude and latitude coordinates in block 334, photos, video or other media in block 336, and description of the Tet offensive in block 338. Veteran 10 may have been on the ground in Saigon during the conflict. Webpage 330 can also show data from the personal profile and general information in FIG. 7, such as branch of service, service unit, duty station, commanding officer, and rank during time period of keypoint 306. Timeline 300 can be shown above keypoint 306 in webpage 330.

Keypoints 302-312 identify the veteran or active duty person as being associated with the events described in one or more of the keypoints. If the user is interested in contacting the veteran or active duty person based on the content of keypoints 302-312, then CSISP 14 can provide a connection between the user and the identified veteran or active duty person from the selected keypoint to engage in commercial or social activity, as described in FIG. 2.

In another search example, the user can access a chronicle of a branch of the service, or a chronicle of the military overall within a given time period, as told by the accounts of the veterans and active duty personnel who served and recorded as keypoints in central database 42. For example, the user is interested in a history of the Army from 1940-2010. The user enters “1940-2010” in block 174 and “Army” in block 178. CSISP 14 retrieves the records from central database 42 matching the search criteria and presents the related keypoints as a timeline.

FIG. 19 shows the search results as timeline 340 with a plurality of keypoints from all records in central database 42 applicable to the Army from 1940-2010 in webpage 342. Keypoint 344 relates to World War II from 1941-1945, keypoint 346 relates to the occupation of Germany from 1945 to 1949, keypoint 348 relates to the Korean War from 1950-1953, keypoint 350 relates to the Vietnam War from 1959-1975, keypoint 352 relates to the military action in Lebanon in 1982, keypoint 354 relates to the invasion of Granada in 1983, keypoint 356 relates to the Persian Gulf War in 1991, keypoint 358 relates to the War in Afghanistan in 2001-2010, and keypoint 360 relates to the War in Iraq in 2003-2010. Keypoints 344-360 are arranged in chronological order and can be logically grouped. Keypoints 344-360 are retrieved from keypoints entered by veterans 10 and 12 and active duty personnel 16 and 18, as well as historical military records.

A sample photo and summary description from the keypoint can be displayed below timeline 340. Within webpage 342, photo and summary description 364 relate to keypoint 344, photo and summary description 366 relate to keypoint 350, photo and summary description 368 relate to keypoint 356, and photo and summary description 370 relate to keypoint 360.

Timeline 340 establishes a correlation between keypoints 344-360. Keypoints 344-360 are more than a sequence of unique datapoints in time and location but rather related events that define a storyline and historical record from the people with the most knowledge of the specific details. The details between related keypoints may differ and one keypoint may offer a different perspective of the same event than another keypoint but such differences are nonetheless valuable because an accurate and comprehensive historical record necessarily contains a variety of viewpoints. The true story is conveyed by understanding each perspective of the participants to timeline 340.

Keypoints 344-360 identify the veteran or active duty person as being associated with the events described in one or more of the keypoints. If the user is interested in contacting the veteran or active duty person based on the content of keypoints 302-312, then CSISP 14 can provide a connection between the user and the identified veteran or active duty person from the selected keypoint to engage in commercial or social activity, as described in FIG. 2.

The records contained in central database 42 of CSISP 14 can be used to establish a timeline for virtually any sequence of events occurring over a time period in one or more locations. The timeline can provide a chronicle or history of the military or any component of the military. The chronicle or history is unique and valuable in that it is created from accounts of the people who actually served with detailed first-hand knowledge of the specific events.

In another embodiment, the user can be corporations 22 or employers 26 with a job opening. The user may be interested in veterans with a particular job skill. The user can search specialization training and school in block 182 and military occupation code in block 183, as well as other personal profile data and keypoints, for veterans having the requisite skills or experience. A list of veterans having the requisite skills or experience is presented to the user. The user evaluates the veterans based on personal profile and keypoints. If the user is interested in contacting the veteran based on the personal profile and keypoints, then CSISP 14 can provide a connection between the user and the identified veteran to engage in commercial activity by discussing the job opening.

CSISP 14 is applicable to historical records of organizations other than the military. CSISP 14 can collect and maintain records and perform searches on those records for sport teams, corporations, professional organizations, government, schools, and other organizations with numerous members. For example, players, staff, and fans of a professional sports team can create keypoints to document their experiences and locate other members after leaving the team. A history of the sports team can be compiled from accounts of the players, staff, and fans.

The user can access a chronicle of a player from the sports team within a given time period, as told by the accounts of the player and recorded as keypoints in central database 42. The user enters the player name and dates as search criteria. CSISP 14 accesses and retrieves the records from central database 42 matching the search criteria and presents the related keypoints as a timeline.

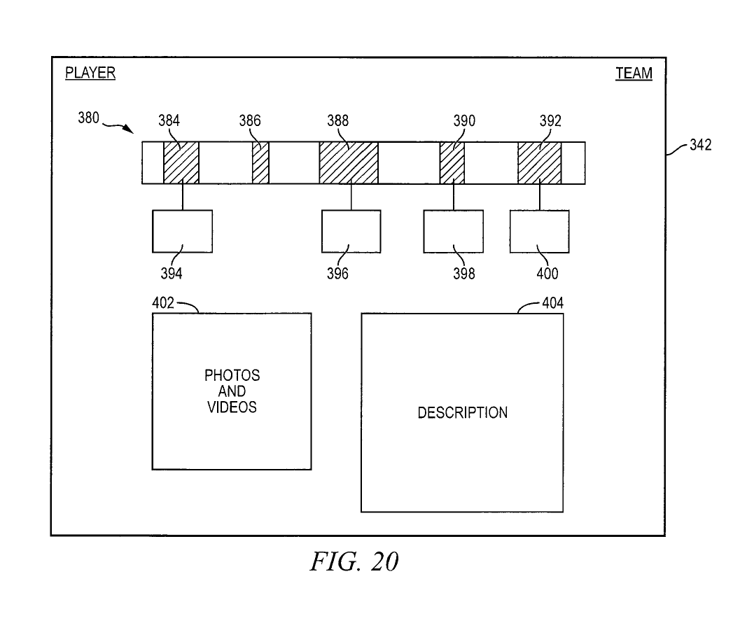

FIG. 20 shows the search results as timeline 380 with a plurality of keypoints from all records in central database 42 applicable to the selected player and date range in webpage 382. Keypoint 384 relates to rookie season, keypoint 386 relates to the playoffs, keypoint 388 relates to an injury, keypoint 390 relates to specific game, and keypoint 392 relates to another playoff run. Keypoints 384-392 are arranged in chronological order and can be logically grouped. Keypoints 384-392 are retrieved from keypoints entered by the player, as well as team records.

A sample photo and summary description from the keypoint can be displayed below timeline 380. In webpage 382, photo and summary description 394 relate to keypoint 384, photo and summary description 396 relate to keypoint 388, photo and summary description 398 relate to keypoint 390, and photo and summary description 400 relate to keypoint 392. Timeline 380 establishes a correlation between keypoints 384-392. The sports team can offer memorabilia associated with the player or other goods or services as described in photos, video or other media in block 402 and description in block 404.

In a similar manner, the employees of a corporation can create keypoints to document their experiences and locate other employees after transfer or retirement. A history of the corporation can be compiled from accounts of the employees. The members of a professional organization can create keypoints to document their experiences and locate other members after transfer or retirement. A history of the professional organization can be compiled from accounts of the members. The students and staff of a school can create keypoints to document their experiences and locate other students and staff after leaving the school. A history of the school can be compiled from accounts of the students and staff.

Advertisers, sponsors, and promoters can access CSISP 14 to identify and communicate with people associated with the organizations stored in central database 42. In one example, a company or marketing organization can offer specific goods and services to target consumers with a common interest or history. The company or marketing organization searches central database 42 to identify and make contact persons who have expressed the interest targeted by the company. If the company sells hunting apparel and supplies and wants to target veterans who have expressed an interest in hunting, then the company enters “hunting” in block 200 of FIG. 9. CSISP 14 accesses and retrieves records from central database 42 and provides the company with a list of persons matching the search criteria.

In another example, a retired member of a professional organization may want to locate other retired members of the organization to establish community service projects. The retired member searches central database 42 to identify and make contact with other retired members of the organization to invite them to participate in the community service project. Former students of a school may want to locate other former students for a reunion. The former student searches central database 42 to identify and make contact with other former students to invite them to the reunion.

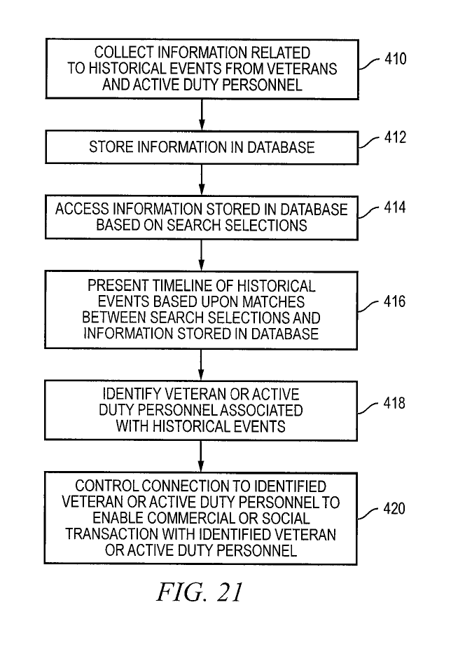

FIG. 21 illustrates a process for controlling a commercial and social system by enabling connections between members to engage in commercial or social activity. In step 410, information related to historical events is collected from veterans and active duty personnel. The historical events are entered as keypoints based on time and location. The keypoints include photos, video, and description of the historical events. Personal profile information for the veterans and active duty personnel is also collected and stored in the database. In step 412, the information is stored in a database. In step 414, the information stored in the database is accessed based on search selections. The search selections include name, address, date, location, branch of service, boot camp, specialization training and school, service unit, deployment, duty station, rank or grade, commanding officer, military academy or college, security classification, medals, decorations and commendations, personal interests, and key words. In step 416, a timeline of the historical events is presented based upon matches between the search selections and information stored in the database. The timeline can include sub-timelines of the historical events. In step 418, a veteran or active duty personnel associated with the historical events is identified. In step 420, a connection to the identified veteran or active duty personnel is controlled to enable a commercial or social activity with the identified veteran or active duty personnel.

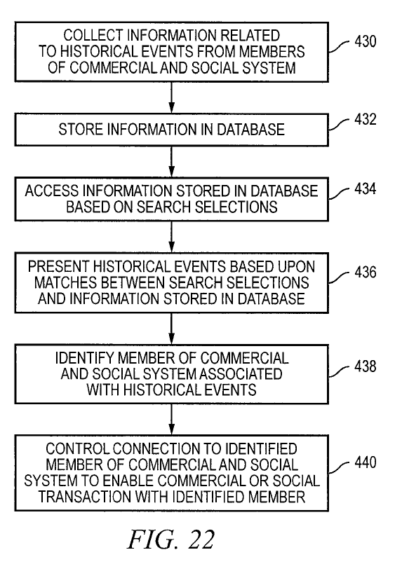

FIG. 22 illustrates another process for controlling a commercial and social system by enabling connections between members to engage in commercial or social activity. In step 430, information related to historical events is collected from members of the commercial and social system. The members of the commercial and social system can be veterans or active duty personnel. The historical events are entered as keypoints based on time and location. The keypoints include photos, video, and description of the historical events. Personal profile information for the members of the commercial and social system is also collected and stored in the database. In step 432, the information is stored in a database. In step 434, the information stored in the database is accessed based on search selections. In step 436, the historical events are presented based upon matches between the search selections and information stored in the database. The historical events can be presented as a timeline. The timeline can include sub-timelines of the historical events. In step 438, a member of the commercial and social system associated with the historical events is identified. In step 440, a connection to the identified member of the commercial and social system to enable a commercial or social activity with the identified member.

In summary, the CSISP operates in part to enable and control connections between individuals of a commercial and social network for the purpose of engaging in commercial and social activities. The CSISP collects profiles and keypoints related to individuals within the commercial and social network. The information is stored in a database. The CSISP provides search features to enable users to identify and locate persons with specific attributes or experiences that are relevant or of interest to the user. CSISP controls and enables a connection to the identified person. The user can engage that person within the commercial and social system to transact commercial and social activities. Accordingly, CSISP enables control of a commercial and social network by collectively describing events and connecting individuals based upon commonly shared experiences.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of controlling a commercial and social system, comprising:
collecting information related to historical events from veterans and active duty personnel;
storing the information in a database;
providing search selections;
accessing the information stored in the database based on the search selections;
presenting a timeline of the historical events based upon matches between the search selections and information stored in the database;
identifying a veteran or active duty personnel associated with the historical events; and
controlling a connection to the identified veteran or active duty personnel to enable a commercial or social activity with the identified veteran or active duty personnel.

2. The method of claim 1, further including entering the historical events as keypoints based on time and location.

3. The method of claim 2, wherein the keypoints include photos, video, and description of the historical events.

4. The method of claim 1, further including:
collecting personal profile information for the veterans and active duty personnel; and
storing the personal profile information in the database.

5. The method of claim 1, wherein the search selections include name, address, date, location, branch of service, boot camp, specialization training and school, service unit, deployment, duty station, rank or grade, commanding officer, military academy or college, security classification, medals, decorations and commendations, personal interests, and key words.

6. The method of claim 1, wherein the timeline includes sub-timelines of the historical events.

7. A method of controlling a commercial and social system, comprising:
collecting information related to historical events from members of the commercial and social system;
storing the information in a database;
accessing the information stored in the database based on search selections;
presenting the historical events based upon matches between the search selections and information stored in the database;
identifying a member of the commercial and social system associated with the historical events; and
controlling a connection to the identified member of the commercial and social system to enable a commercial or social activity with the identified member.

8. The method of claim 7, wherein the members of the commercial and social system are veterans or active duty personnel.

9. The method of claim 8, wherein the search selections include name, address, date, location, branch of service, boot camp, specialization training and school, service unit, deployment, duty station, rank or grade, commanding officer, military academy or college, security classification, medals, decorations and commendations, personal interests, and key words.

10. The method of claim 7, further including entering the historical events as keypoints based on time and location.

11. The method of claim 10, wherein the keypoints include photos, video, and description of the historical events.

12. The method of claim 7, further including:
collecting personal profile information for the members of the commercial and social system; and
storing the personal profile information in the database.

13. The method of claim 7, further including presenting the historical events as a timeline or map.

14. A method of controlling a commercial and social system, comprising:
collecting information related to historical events from members of the commercial and social system;
storing the information in a database;
accessing the information stored in the database based on search selections;
presenting the historical events based upon matches between the search selections and information stored in the database; and
controlling connections between the members of the commercial and social system to enable commercial or social activity.

15. The method of claim 14, wherein the members of the commercial and social system are veterans or active duty personnel.

16. The method of claim 15, wherein the search selections include name, address, date, location, branch of service, boot camp, specialization training and school, service unit, deployment, duty station, rank or grade, commanding officer, military academy or college, security classification, medals, decorations and commendations, personal interests, and key words.

17. The method of claim 14, further including entering the historical events as keypoints based on time and location.

18. The method of claim 17, wherein the keypoints include photos, video, and description of the historical events.

19. The method of claim 14, further including:
collecting personal profile information for the members of the commercial and social system; and
storing the personal profile information in the database.

20. The method of claim 14, further including presenting the historical events as a timeline or map.

21. A computer program product usable with a programmable computer processor having a computer readable program code embodied in a computer usable medium for controlling a commercial and social system, comprising:
collecting information related to historical events from members of the commercial and social system;
storing the information in a database;
accessing the information stored in the database based on search selections;
presenting the historical events based upon matches between the search selections and information stored in the database; and
controlling connections between the members of the commercial and social system to enable commercial or social activity.

22. The computer program product of claim 21, wherein the members of the commercial and social system are veterans or active duty personnel.

23. The computer program product of claim 22, wherein the search selections include name, address, date, location, branch of service, boot camp, specialization training and school, service unit, deployment, duty station, rank or grade, commanding officer, military academy or college, security classification, medals, decorations and commendations, personal interests, and key words.

24. The computer program product of claim 21, further including entering the historical events as keypoints based on time and location.

25. The computer program product of claim 21, wherein the keypoints include photos, video, and description of the historical events.
